(19) United States
(12) Patent Application Publication
(10) Pub. No.: US 2005/0138422 A1
(43) Pub. Date: Jun. 23, 2005

(54) System and method for metering the performance of a data processing system

(76) Inventors: Peter J. Hancock, White Bear Lake, MN (US); Lee B. Hansen, Forest Lake, MN (US); Daniel J. Lenz, Maplewood, MN (US); Hans C. Mikkelsen, Afton, MN (US); Ronald S. Tanning, Roseville, MN (US); Philip M. Hoffman, Oreland, PA (US)

Correspondence Address: Beth L. McMahon;Unisys Corporation, MS 4773, P O Box 64942, St. Paul, MN, 55164, US

(21) Appl. No.: 10/744,685

(22) Filed: Dec. 23, 2003

(51) Int. Cl. H04L 9/00

(52) U.S. Cl. 713/201

(57) ABSTRACT

A system and method for metering usage of a data processing system and scaling system performance is disclosed. In one embodiment, an authorization key is purchased that specifies both a baseline performance level and a ceiling performance level. The cost of the baseline and ceiling performance levels is included in the price of the key. After the key is installed on the data processing system, the system performance level is monitored and averaged over predetermined time periods. The customer is charged on a “pay-as-you-go” basis for any time periods during which the average performance level exceeds the baseline performance level. Performance of the data processing system is not allowed to exceed the ceiling level obtained with the authorization key. In one embodiment, the baseline level may be set to zero so that all performance consumption is purchased by the customer as it is utilized.

### Reference to Co-Pending Applications

The following commonly assigned co-pending applications have some subject matter in common with the current application:

Attorney Docket Number RA-5311 “Authorization Key System for Selectively Controlling the Performance of a Data Processing System”, Ser. No. 09/676,162 filed Sep. 29, 2000, and which is incorporated herein by reference.

Attorney docket number RA-5639 entitled “System and Method for Scaling Performance of a Data Processing System” filed on even date herewith.

Attorney docket number TN301/USYS-0141 entitled “Method and System for Economic Valuation in Partitioned Computer Systems”, filed on even date herewith.

### FIELD OF THE INVENTION

The current invention relates generally to data processing systems, and more particularly to methods and apparatus for selectively controlling the performance of data processing systems.

### BACKGROUND OF THE INVENTION

Many growing businesses are challenged with ensuring that their data processing systems keep pace with expanding demands. This is particularly true for rapidly growing e-commerce companies, but also applies to other companies as well.

Another challenge facing many businesses is that of predicting and handling the peak loads that will be required to keep up with the day-to-day operations. For example, if there is a delay in gathering year-end data, there may be little time to process the data before the results must be published or otherwise released. The processing power required to handle such year-end data on such short notice may exceed the processing power of the available computer resources. In another example, e-commerce servers may experience severe peak loads during certain times of the year, such as the Christmas season. The extent of these peak loads is also often difficult to predict.

One way to increase processing power is to acquire additional processing systems. This can be expensive, and is not desirable if the additional systems are only required to address peak loads that exist during relatively short time periods. Another way to increase processing power is to modify existing systems. This may involve installing additional processors or memory, for example. However, system updates may necessitate the termination of normal processing activities so that the system can be powered down or otherwise placed in a state that accommodates maintenance. This can significantly disrupt the operations of the business. Moreover, updating a system to take into account peak demand is undesirable if this worst-case scenario rarely occurs.

One way to address the foregoing challenges involves allowing for the temporary increase of resources only when those resources are required to achieve a desired performance level. This is accomplished by including additional resources such as processors and memory in the data processing system when it is provided to the customer. However, only the resources that are required to achieve the performance purchased by the customer are enabled for use during normal operation. To temporarily or permanently increase the performance level of the data processing system, the customer may purchase an authorization key to enable the use of additional hardware resources. The authorization key may, for example, identify which additional processing resources are being authorized for use, the maximum time the additional resources are authorized for use, and an expiration date. This authorization key thereby allows selective increases in performance level to accommodate unplanned increases in performance requirements. When peak demand has ended, the customer may return to average processing levels without incurring the cost burden associated with permanently upgrading a system or obtaining additional systems.

Commonly-assigned U.S. patent application entitled “Authorization Key System for Selectively Controlling the Performance of a Data Processing System”, Ser. No. 09/676,162 filed Sep. 29, 2000, and which is incorporated herein by reference in its entirety, discloses an exemplary system of the type described in the foregoing paragraph. According to one embodiment of the disclosed system, the customer purchases a first authorization key that is delivered with the system. This key enables a first set of processing resources. If the customer later desires the option of enabling additional resources to increase system performance, a second authorization key may be purchased.

Prior art systems such as that described above generally select a performance level by identifying the system resources that will be enabled. For example, authorization keys provided with the system specifically identify the processors that are enabled for use. If one of these identified processors encounters some type of hardware problem, the customer is not allowed to instead employ one of the other available processors that is not specified by the key. Thus, encountered hardware problems may result in degraded throughput.

Another aspect of prior art systems involves the fact that authorization keys specify the number of processors that may be enabled within the system, not the processing power actually available from those processors. However, the processing power that will be obtained from a predetermined number of processors varies based on architectural characteristics of the data processing system. For example, four processors that are coupled to a shared cache may provide significantly more processing throughput than if two processors are operating from a first shared cache, while the remaining two processors utilize a different shared cache. Thus, the customer may not always be obtaining peak performance from the enabled resources.

An additional consideration associated with prior art systems relates to the use of multiple partitions within a data processing system. A partition is a grouping of resources that are allocated to execute in a cooperative manner to perform one or more assigned tasks. For example, a partition may be formed that includes one or more predetermined instruction processors and Input/Output Processors (IOPs), and a predetermined memory range within a shared main memory. A second partition may be created to include different processors, IOPs, and another memory range. Each of these partitions may operate independently from the other so that a number of tasks may be executed in parallel within the system. When system needs change, the partitions can be re-defined. For instance, if needed, all resources may be allocated to the same partition and assigned to execute a high-priority task.

Some prior art keys are “partitionable”, meaning these keys support the use of partitioning. Partitionable keys can be activated in a single partition, or in multiple partitions. For example, assume a partitionable key allows six identified processors to be enabled. These processors may be allocated to the same partition. Alternatively, two partitions may be created, each including three of the identified processors. When all six of the identified processors are in use, the operating system prevents the use of any more processors in any of the partitions.

Prior art partitionable keys do not account for system characteristics. For example, assume in the above example that three of the six identified processors share a first cache, and the remaining three processors share another cache. In this type of configuration, a single partition containing all processors will deliver less processing power than two partitions that each include a cache and the respective processors. This is true because of the loss of throughput that occurs when data must be shared between two caches of the same partition. Because the partitionable keys do not take into account such architectural considerations, the customer may not always be obtaining peak performance from the enabled resources. Additionally, since one partitioning configuration may provide more processing power than another configuration, the keys are difficult to price fairly.

What is needed, therefore, is an improved system and method for controlling and scaling the performance of a data processing system in a manner that addresses the foregoing issues.

### SUMMARY OF THE INVENTION

The following invention provides an improved system and method for metering usage and scaling performance of a data processing system. In one embodiment, an authorization key is purchased that specifies both a baseline performance level and a ceiling performance level. These performance levels may be specified using a metric that describes processing throughput, such as Millions of Instructions Per Second (MIPS).

The cost of the baseline performance levels is included in the price of the key. After this key is installed on the system, the utilized performance of the data processing system is monitored and averaged over predetermined time periods. The customer is periodically issued an invoice that charges for any time period during which this averaged system utilized performance exceeds the baseline performance level. So long as the averaged system utilized performance remains below the pre-paid baseline performance level, the customer is not charged an additional amount. Performance of the data processing system is not allowed to exceed the ceiling level obtained with the authorization key.

In one embodiment, the data processing system can be configured in any selected one of multiple configurations. Each configuration is associated with a maximum performance level. The utilized performance of the data processing system is calculated based on the time spent performing work by each processor within the selected configuration. The utilized performance is also based on the maximum performance level for the selected configuration.

According to one aspect of the invention, the customer may programmably change the ceiling level, and is charged accordingly on their invoice. If desired, the baseline level may be set to zero by the system provider such that all performance consumption is purchased by the customer as it is used. In another embodiment, the ceiling level may be set to 100 percent so that system performance is not throttled.

According to one embodiment, baseline and ceiling performance levels are specified without any restrictions on the hardware that may be used to achieve these levels. The customer may therefore select which resources within the data processing system will be enabled, as well as how those resources will be configured.

The concept of using performance levels to scale and meter a data processing system can best be appreciated by example. Assume that a data processing system includes multiple IPs. A customer may choose to enable any or all of these IPs to achieve up to the purchased ceiling performance level. The performance of each of the IPs will automatically be scaled so that the overall performance of the data processing system does not exceed the purchased ceiling performance level.

In one embodiment, the customer may create one or more processing partitions to include the one or more enabled IPs. For instance, all enabled IPs may be included in the same partition, or may be divided between multiple partitions. Characteristics associated with the system architecture will be taken into account when scaling the performance of each IP in a partition so that the system as a whole will provide up to the purchased ceiling performance level.

According to the foregoing embodiment, performance of an IP may be scaled using a scaling factor that is derived using one or more lookup tables. These tables contain data indicating the peak performance level that will be provided by any allowable configuration of the data processing system. After the customer selects a configuration, the applicable scaling factor is calculated by dividing the purchased ceiling performance level by the peak performance level for the selected configuration. This scaling factor is then used to scale the processing power of each IP that is enabled within the configuration so that performance of the system does not exceed the ceiling level.

In a variation of the foregoing, a customer may select a configuration that includes multiple processing partitions. Each partition is allocated a portion of the total ceiling performance level. A ceiling scaling factor is created for each partition by dividing the portion of the allocated ceiling performance level by the peak performance level for that partition. The ceiling scaling factor is then used to scale the performance level of each IP within the partition.

In an embodiment wherein multiple processing partitions are utilized, the processing activities of each processor in each partition are monitored. The utilized performance of each of the partitions may then be calculated based on the portion of time spent by the processors in the partition performing work, as well as the maximum performance level that may be provided by the partition. The utilized performance of the system may then be derived by adding the utilized performance for each of the partitions. This system utilized performance is averaged over a predetermined averaging time period. The customer is billed based on this averaged system utilized performance. In one embodiment, the customer is billed based on an amount this averaged system utilized performance exceeds the baseline performance level. According to one aspect of the invention, the customer is billed for consumption, which is determined as a product of the averaged system utilized performance and the averaging period.

In one embodiment, the invention provides a method of metering performance of a data processing system. The method includes monitoring the performance of the data processing system, and charging a customer based on utilized performance that exceeds a baseline performance level.

According to another embodiment, a data processing system is provided that includes one or more processors, a memory coupled to the processors, and Software Controlled Performance Facility (SCPF) software stored within the memory to monitor performance of at least one of the processors, and to charge a customer based on the performance that is utilized.

In yet another embodiment, a system for charging for performance of a data processing system is disclosed. The data processing system includes one or more processors, means for recording performance of the one or more processors, and means for determining system utilized performance of the data processing system from the recorded performance of the one or more processors. The system further includes means for charging a customer based on the system utilized performance of the data processing system.

Other scopes and aspects of the invention will become apparent from the following description and the accompanying drawings.

### BRIEF DESCRIPTION OF THE DRAWINGS

FIG. 1 is a block diagram of an exemplary system that may employ the current invention.

FIG. 2A is a diagram of an exemplary prior art authorization key.

FIG. 2B is a diagram of an exemplary prior art optional authorization key.

FIG. 3A is a graph illustrating one embodiment of the invention.

FIG. 3B is a diagram of a performance-based authorization key.

FIG. 4A is a table illustrating the maximum performance delivered by various configurations of a system such as that shown in FIG. 1.

FIG. 4B is a block diagram illustrating one embodiment of the inventive system wherein the Software Controlled Performance Facility is included within the kernel of the operation system.

FIG. 4C is a block diagram illustrating another embodiment of the current invention wherein the Software Controlled Performance Facility is a centralized entity.

FIG. 5 is a flow diagram illustrating one embodiment of a method according to the current invention.

FIG. 6 is a flow diagram illustrating one embodiment of a method of allocating the ceiling performance levels to one or more partitions in the manner discussed above.

FIG. 7A is a flow diagram of one embodiment of scaling and monitoring the performance levels of each IP in a partition according to the current invention.

FIG. 7B is a diagram illustrating one process for determining the utilization of a partition.

FIG. 8 is a flow diagram describing the derivation of utilization and consumption metrics for the partitions controlled by a partitionable metered key.

FIG. 9 is a flow diagram describing the manner in which consumption metrics may be reported to the customer and to a billing authority.

### DETAILED DESCRIPTION OF THE INVENTION

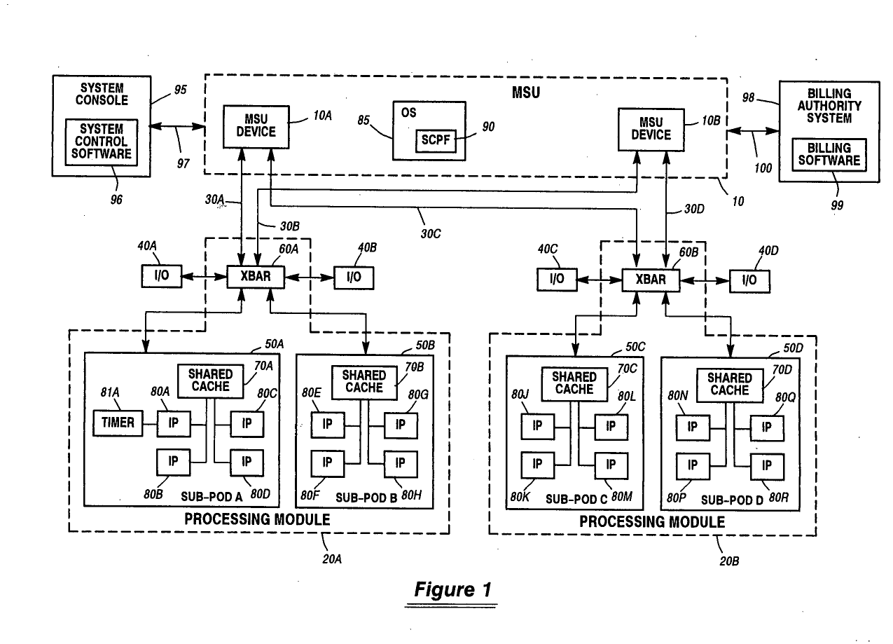

FIG. 1 is a block diagram of an exemplary system that may employ the current invention. This system includes a Memory Storage Unit (MSU) 10 (shown dashed) which provides the main memory facility for the system. The MSU includes one or more MSU devices individually shown as MSU 10A and MSU 10B, which each contains a predetermined portion of the memory space of the system. Many more MSU devices may be included within a full configuration.

The system further includes Processing mODules (PODs) 20A and 20B (shown dashed), which provides the processing capability for the system. A greater or lesser number of PODs may be included in the system than are shown in FIG. 1. In one embodiment, up to four PODs are included in a fully populated system.

Each of the PODs is coupled to each of the MSU devices via a dedicated, point-to-point connection referred to as an MSU Interface (MI), individually shown as MIs 30A through 30D. For example, MI 30A interfaces POD 20A to MSU device 10A, MI 30B interfaces POD 20A to MSU 10B device, and so on.

Each POD includes two Sub-Processing modules (Sub-PODs) and a crossbar module (XBAR). For example, POD 20A includes sub-PODs 50A and 50B and XBAR 60A, and so on. Each sub-POD is interconnected to the respective crossbar module (XBAR) through a dedicated point-to-point interface.

The system of FIG. 1 may further include Input/Output modules (I/Os) individually shown as I/Os 40A through 40D. The I/O modules provide the interface between various Input/Output devices or communications links and a respective one of the PODs 20. Each I/O module is coupled to a POD via the POD's XBAR. For example, I/O 40A is coupled to XBAR 60A, and so on. XBAR 60A both buffers data for the respective sub-PODs 50A and 50B and I/O modules 40A and 40B, and functions as a switch to route data between any of these sub-PODs and I/O modules to an addressed one of the MSU devices 10A and 10B.

In the exemplary system of FIG. 1, each sub-POD includes a shared cache and one or more Instruction Processors (IPs). For example, sub-POD 50A includes shared cache 70A and IPs 80A-80D. Other sub-PODs are similarly configured. In one embodiment, a sub-POD 50 may include between one and four IPs 80. Each IP may include one or more dedicated caches and interface logic for coupling to the interface with the shared cache. The shared cache stores data for each of the IPs within its sub-POD. Finally, each IP includes a quantum timer shown as timer 81A for IP 80A. This timer has many uses, including the facilitation of multi-tasking for the respective IP, as will be discussed below.

The system of FIG. 1 includes at least one instance of an Operating System (OS) that is loaded into MSU 10 to control the system. OS 85 is shown generally occupying memory included within MSU 10, and it will be understood the selected memory range in which OS 85 resides will actually be provided by one of MSU devices 10A or 10B.

Also shown residing with MSU 10 is at least one instance of a Software Controlled Performance Facility (SCPF) 90. The SCPF may be implemented in the kernel of OS 85 as shown in FIG. 1, or implemented as a stand-alone entity. In either case, the SCPF controls the performance level of each of the IPs 80 within the system, as will be discussed further below.

The system of FIG. 1 includes a system console 95, which may be a workstation, personal computer, or some other processing system executing system control software 96. This system console is coupled to the other units in the system via a scan interface 97. Although for simplicity, the scan interface is shown coupled solely to MSU 10, it will be understood it is coupled to the other units in the system as well.

System console provides all initialization, maintenance, and recovery operations for the system via the scan interface. In addition, system console may be employed by an operator to perform configuration activities in a manner to be discussed below.

Finally, the data processing system is coupled to a billing authority system 98 via a network 100 such as the Internet, or any other suitable type of network capable of supporting secure data transfers. This billing authority system is a data processing system that will generally be located at a remote location as compared to the data processing system, and will execute billing software 99. The billing software 99 utilizes data obtained from SCPF 90 to generate invoices charging the customer for utilization of the data processing system. This will be discussed below in reference to the remaining drawings.

It will be appreciated that the system of FIG. 1 is merely provided for discussion purposes. Any other data processing system having any other type of configuration may usefully employ the inventive system and method to be discussed in the following paragraphs. With the foregoing available for discussion purposes, the current invention is described in regards to the remaining drawings.

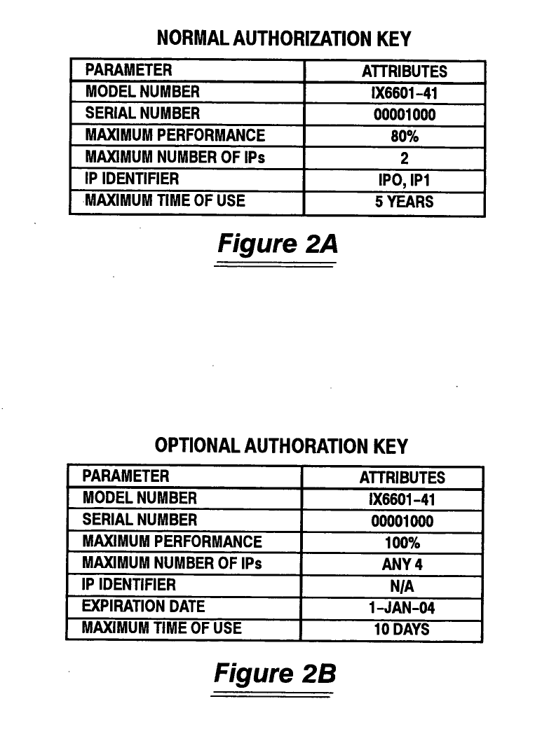

FIG. 2A is a diagram showing an illustrative prior art authorization key. This key is a “normal” authorization key that is intended for relatively long-term use. The illustrated key has a maximum time of use of five years. Instead of, or in addition to, this maximum time of use, the key may include an expiration date dictating the last day on which the key may be used. A system and method for utilizing authorization keys of the type shown in FIG. 2A are disclosed in commonly-assigned U.S. patent application entitled “Authorization Key System for Selectively Controlling the Performance of a Data Processing System”, Ser. No. 09/676,162, filed Sep. 29, 2000, which is incorporated herein by reference in its entirety.

The exemplary key of FIG. 2A authorizes use of two processors identified as “IP0” and “IP1” in the IP identifier field. The allowable maximum performance utilization for each of these IPs is set to 80%. This key further specifies the model and serial numbers of the target data processing system that will use the key. This data processing system may be similar to that shown in FIG. 1, for instance. The model and serial numbers specified in the authorization key may be used to validate the authorization key when it is registered on the data processing system. For example, when the authorization key is registered, the model and serial numbers specified in the authorization key are compared with the model and serial number of the data processing system. If this data does not match, the authorization key may be rejected as invalid.

Assume the authorization key illustrated in FIG. 2A is initially provided with a data processing system having two sub-PODs 50 and eight. IPs 80. The authorization key specifies the maximum number of authorized IPs as two. The authorization key also uniquely identifies IP0 and IP1 as being the IPs that are available for use. As a result, six of the IPs in the system initially remain unused.

In one embodiment, a corresponding configuration file (not shown) is provided to map the identifiers “IP0” and “IP1” specified in the authorization key to specific hardware within the system. For example, a configuration file may correlate the name “IP0” with IP 80A of sub-POD 50A by identifying a slot and chip location that is populated by IP 80A.

As discussed above, SCPF 90 is a software utility that is provided to control which IPs are enabled, as well as the peak utilization rate that is allowable for each of the enabled IPs. If the customer attempts to enable, or “up”, any of the processors other than IP0 and IP1, SCPF will issue a warning message and prevent the enabling of the identified IP.

The exemplary authorization key of FIG. 2A allows each IP to run at 80% of its maximum utilization potential. To control this maximum utilization percentage, the SCPF utility will cause IP0 and IP1 to enter a forced idle state for a specified percentage of time, which in this case is 20%. During this time, the IP is not performing useful work. This forced idle state is preferably achieved at the expense of non-critical system and user activities. The processing of critical system events such as interrupts, including pre- and post-processing of I/O interrupts, memory paging, and so on, are preferably not delayed during forced idle states. The forced idle state is enforced on an IP basis rather than a system wide basis.

The forced idle state may be implemented using the multitasking capabilities of the system. As is known in the art, a multitasking environment allows an IP to execute multiple tasks, with each task being executed during a predetermined quantum of time. After the time for execution of a given task expires, the OS causes the IP to begin executing another task for the next quantum of time, and so on.

To facilitate multitasking, the OS must re-gain control of the IP at somewhat regular time intervals. This can be accomplished in a number of ways. Generally, a task that is executing on an IP periodically requests a service from the OS, thereby relinquishing control of the IP. This can be used as an opportunity to allow the OS to initiate execution of another task on the IP. Occasionally, however, a task may execute for long periods of time without relinquishing control to the OS. To prevent such execution from continuing for an extended period of time, the OS uses a quantum timer such as timer 81A to regain control of the IP. If a task continues execution beyond its allocated quantum of time, the quantum timer will expire to interrupt task execution. Control is returned to the OS so that another task can begin execution.

The foregoing environment may be utilized to scale performance of an IP as follows. When the OS gains control after task execution has been interrupted in any of the ways described above, SCPF 90 may, if necessary, force the IP to execute in a looping construct in which no useful work is done. The amount of time spent in the forced idle loop will be adjusted as necessary to cause the partition to run at a predetermined performance level specified by the system authorization key. SCPF monitors a system clock to cause the IP to execute within the idle loop until the predetermined scaled performance level is achieved. Preferably, the increments of time spent within a forced idle state are sufficiently small so as not to be discernable by a user. After the time required for execution within the forced idle loop has elapsed, the IP may be directed to resume execution of the next scheduled processing task. This will be discussed further below.

According to the current embodiment, SCPF 90 will prevent a customer from attempting to increase the utilization of the available processors beyond the authorized maximum utilization percentage, which is also referred to as “the ceiling”.

Next, assume the customer is experiencing a workload that cannot be adequately handled by the normal authorization key. To address this situation, the customer may purchase an optional authorization key.

FIG. 2B is an exemplary prior art optional authorization key. Like the key shown in FIG. 2A, this key includes a model and serial number of the target data processing system, an IP identifier field indicating the IPs that are available for use, and the maximum performance utilization allowed for those authorized IPs. This key may increase the number of IPs authorized for use, and/or the maximum utilization percentage for the authorized IPs. For example, the key of FIG. 2B indicates that any four IPs may be utilized at a processing rate of 100%.

An optional key is generally adopted for relatively short-term use as compared to a normal authorization key. In a manner similar to normal keys, this type of key may include an expiration date and/or a maximum usage time. For example, the key of FIG. 2B is valid for a period of ten days, and expires on Jan. 1, 2004. In a preferable embodiment, the optional authorization key can be used cumulatively for ten days, and need not be used for ten consecutive days. Once the expiration date of the optional authorization key arrives, or the key is used for more than ten days, SCPF 90 automatically returns the data processing system to the original configuration, which may be governed by the use of a normal authorization key such as that shown in FIG. 2A. In one embodiment, SCPF provides one or more messages to the customer, warning the customer of the impending configuration change. This may give the customer the opportunity to purchase an additional optional authorization key before the data processing system is returned to the original configuration.

As can be appreciated by the foregoing, the use of an optional authorization key is particularly suited for a situation wherein a customer is experiencing a short-term workload increase. If it is anticipated that the increased workload will be sustained, the customer may purchase a normal authorization key that increases system performance for a longer time period.

The prior art system and method discussed above provides a flexible approach to increasing system performance. Performance can be increased without disrupting normal operations. Moreover, the performance increase may be tailored to a customer's specific needs. The customer is only required to purchase the amount of additional processing power for the limited time that processing power is needed. While this provides significant advantages, the flexibility of the prior art system may be improved. For example, prior art normal authorization keys specifically identify the IPs that are available for use. As a result, the customer does not have the discretion to disable one IP and instead employ a different IP, as may be desirable if a failure occurs within one of the executing IPs.

Another aspect of the prior art system involves the way in which the performance is specified. As previously discussed, a key describes the purchased processing power in terms of the number of processors that are available for use, and the percentage of utilization for each of the available processors. However, in some system configurations, these specifications do not necessarily accurately describe a predetermined performance level.

The foregoing observation can be appreciated by considering the optional authorization key of FIG. 2B. This key allows a user to employ any four IPs at 100%. However, in an exemplary system such as shown in FIG. 1, the customer will obtain different processing throughput levels based on which IPs are selected for use. For example, if IPs 80A-80D within sub-POD 50A are employed, the user will obtain significantly better performance than if two IPs are utilized in sub-POD 50A, and two IPs are enabled in sub-POD 50B. This is the result of performance benefits obtained when all IPs execute from the same shared cache 70A. Thus, a given prior art authorization key may result in differing levels of performance based on the way in which the customer is using the key. This drawback may be addressed by specifically identifying the IPs that are available for use in a manner similar to that shown in FIG. 2A. However, this restricts the user's ability to make hardware substitutions when faults are detected, as is discussed above.

Another concern associated with prior art systems involves the use of processing partitions. As discussed above, a partition is comprised of resources that are allocated to execute in a cooperative manner to perform one or more assigned tasks. For example, a partition may be created that includes one or more predetermined IPs and I/O modules, and a predetermined memory range within MSU 10. A second partition may be defined to include different IPs, I/O modules and another memory range. Each of these partitions may operate independently to execute respectively assigned tasks in parallel with those tasks being executed by other partitions. Partitions may be re-defined as system requirements change.

Some prior art keys are “partitionable”, meaning these keys support the use of partitioning. Partitionable keys can be activated in a single partition, or in multiple partitions. For example, assume a partitionable key authorizes the use of six identified IPs. All of these IPs may be allocated to the same partition. Alternatively, two partitions may be created, each including three of the identified processors.

Prior art partitionable keys do not take into account performance differences between various partitioning alternatives. For example, two partitions that each includes three IPs deliver considerably more processing power than a single partition that includes six IPs. Thus, it is difficult to price a partitionable key fairly.

Finally, prior art keys are rated in terms of a maximum performance level. A customer must pay for this maximum level during the entire time the key is used on the system, even if system usage only approaches the maximum level infrequently during that time.

The current invention provides an improved system and method for allowing the customer to pay for the processing power that is actually used, rather than requiring the customer to purchase an estimated maximum performance level ahead of time. In one embodiment, the inventive system measures processing power by specifying a performance level delivered by the system, rather than the number of processors that will deliver the processing power.

### II. DESCRIPTION OF THE INVENTION

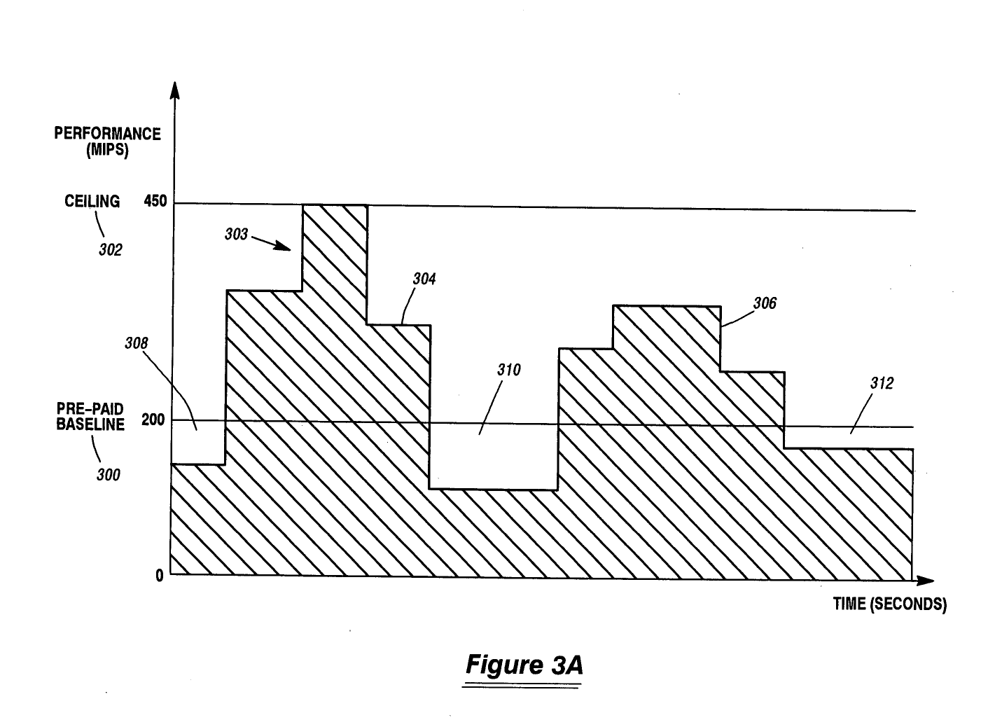

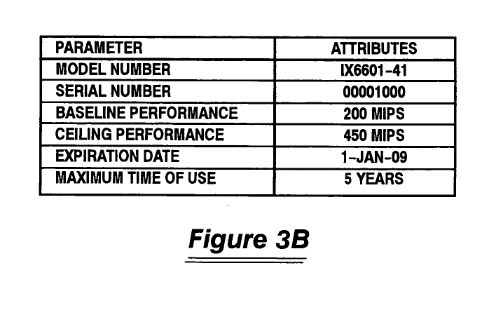

FIG. 3A is a graph illustrating an embodiment of the invention. According to the invention, an authorization key is associated with both a baseline and a ceiling level of “processing power” that is described in the metric Millions of Instructions Per Second (MIPS). Processing power could be described in other suitable units of measure in the alternative. As is known in the art, the MIPS ratings for a data processing system is generally established by measuring the execution times of various benchmark programs.

Because benchmark programs are generally developed with a particular system architecture and operating system in mind, a given suite of benchmarks do not necessarily provide data that can be used to conduct a meaningful comparison between different system architectures. However, a given suite of benchmarks can provide meaningful comparison data when considering the performance of systems that are included within the same or related product families.

The throughput of systems such as the ClearPath plus CS7802 system commercially available from Unisys Corporation is established using a suite of benchmark programs analyzed by International Data Corporation (IDC). These programs measure throughput in a unit of measure referred to as “IDC MIPS”, which hereinafter will just be referred to as “MIPS” for simplicity. Other types of MIPS may be used in the alternative.

Returning to FIG. 3A, this graph illustrates both a baseline performance rating 300 and a ceiling performance rating 302. The exemplary baseline rating is 200 MIPS, and the ceiling rating is 450 MIPS. The customer prepays for the amount of processing power specified by the baseline rating 300. That baseline performance level may be obtained using any combination of system resources selected by the customer. Unlike prior art authorization keys, the identity of the IPs that are available for use are not limited.

The current invention monitors the amount of processing power that is used by the customer in a manner to be discussed below. Processing power is considered to be “used” when it is being used to execute tasks, manage tasks, or schedule tasks for execution. Processing power is not being “used” when the processor is idle. The processor may be idle because there are no tasks in a state for execution (referred to herein as “natural idle”), or because performance of the processor is being scaled (referred to as “forced idle”). When the amount of utilized processing power exceeds the pre-paid baseline, the level of usage is recorded. The customer is periodically billed for this additional processing power. The customer's usage is not allowed to exceed the predetermined ceiling amount that is set based on pricing levels associated with the authorization key.

The foregoing can best be understood by returning to FIG. 3A. In this example, the customer has pre-paid for a baseline performance level of 200 MIPS. The customer may utilize up to 200 MIPS on a continuous basis without being charged for additional processing power. The utilization of processing power is monitored to determine when the customer utilizes more than 200 MIPS over a predetermined monitored time increment, as will be discussed below. The customer is then charged for this additional processing power, which is measured in “MIPS-seconds”. This additional processing power is represented by the areas 304 and 306 of the graph that are bounded by baseline 300 and, in the case of area 304, ceiling 302. When the processing power reaches the ceiling performance level of 450 MIPS, the throughput of the data processing system is throttled so that it will not exceed this ceiling level.

As can be appreciated by FIG. 3A, the current system and method allows a customer to pre-pay for the minimum level of performance that is anticipated to support daily requirements. Any additional processing power that is needed is obtained on a “pay-as-you-go” basis. Processing power is not allowed to exceed a ceiling level that is associated with the pre-paid baseline level.

FIG. 3B is an exemplary authorization key used in one embodiment of the current invention. Like the keys illustrated in FIGS. 2A and 2B, this key includes a model and serial number of the target data processing system. The key may further include an expiration date and/or a maximum usage time. Unlike the keys shown in FIGS. 2A and 2B, however, this key specifies a baseline performance level 300 of 200 MIPS, which is the level for which the customer prepays. A second ceiling performance level 302 of 450 MIPS is also specified. As discussed above, this level limits the customer's maximum performance usage. A monitoring system and method is used to meter the performance level of the customer's system if that performance level exceeds the baseline. The customer is billed at periodic increments for this performance usage, as will be discussed below.

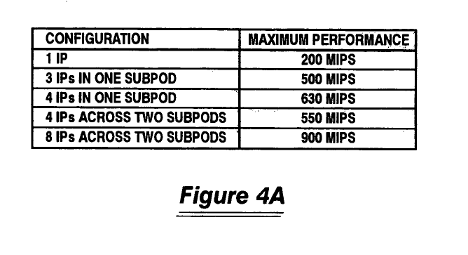

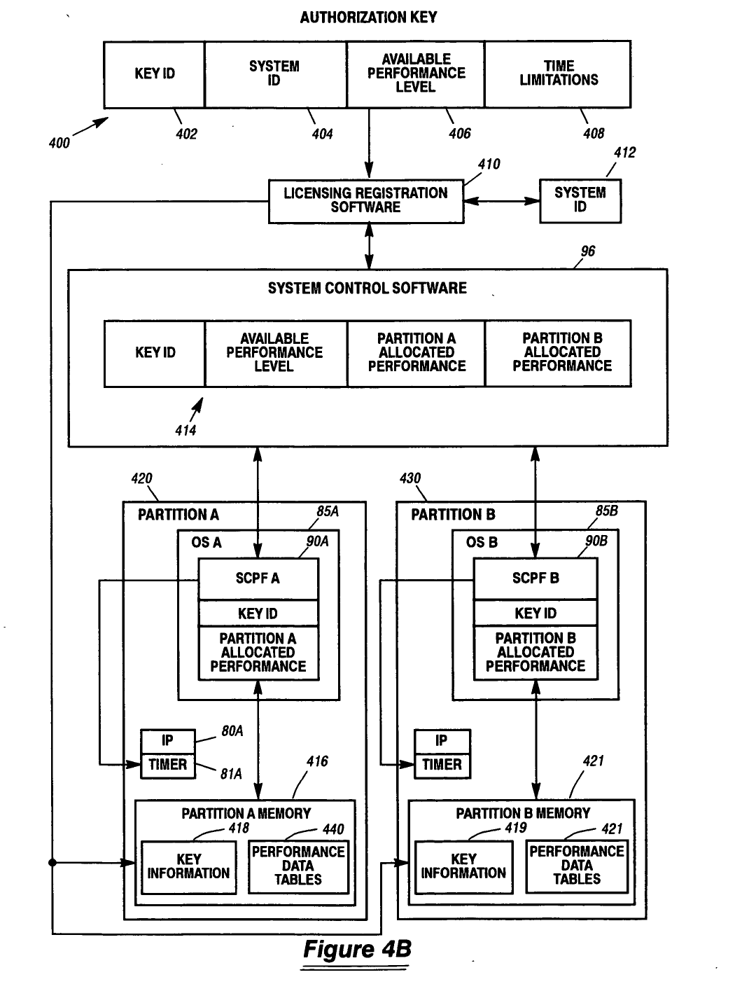

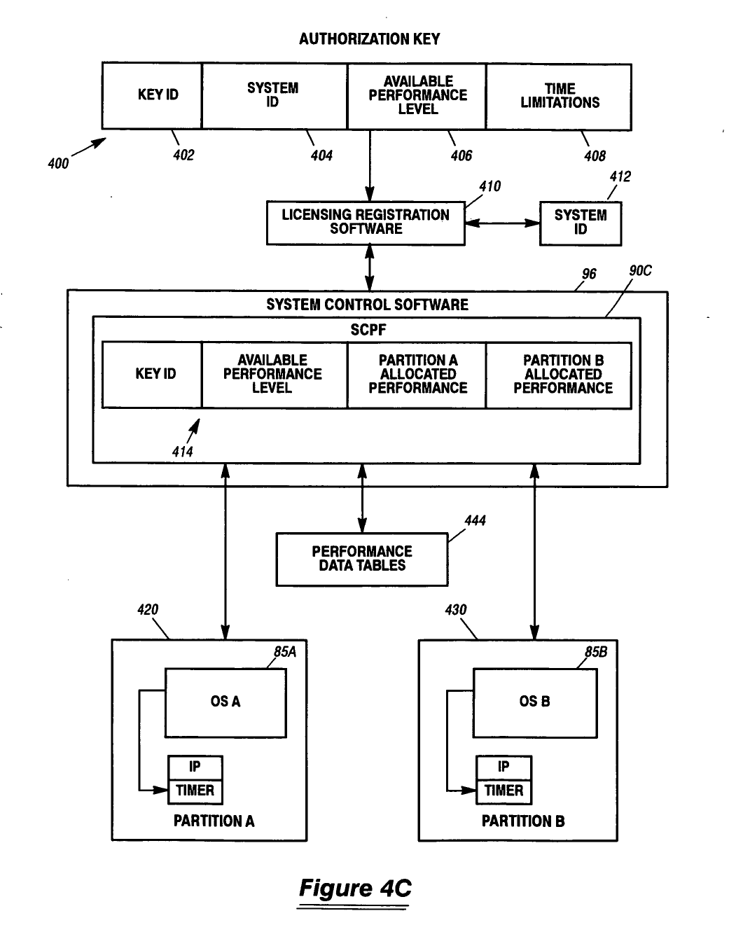

FIG. 4A is a table illustrating the performance level, rated in MIPS, that is delivered when various combinations of IPs are enabled at 100% utilization within a system such as that illustrated in FIG. 1. As discussed above, these ratings may be obtained by running a suite of standard benchmark programs on the system when it is configured in the designated manner. It will be understood that the listed MIPS ratings are not intended to reflect actual performance capabilities of any commercially available system, but are presented merely for discussion purposes.

A review of the table of FIG. 4A indicates that any IP 80 within the system of FIG. 1 delivers 200 MIPS when executing at 100% utilization. Similarly, 500 MIPS are delivered by three IPs that are executing at 100% within the same sub-POD 50. Four IPs residing within one sub-POD deliver 630 MIPS, whereas four IPs residing in two different sub-PODs provide 550 MIPS. Eight IPs executing in two sub-PODs deliver 900 MIPS. This is much less than the nominal 1600 MIPS that would be obtained from eight IPs executing at 200-MIPS because of the multiprocessor effects associated with the system's cache architecture and the benchmarking software's use of shared data. It will be appreciated that for a system such as that shown in FIG. 1 or even larger, a table such as shown in FIG. 4A will have many more entries to reflect all of the different IP combinations that are possible within the system.

A table such as that shown in FIG. 4A provides MIPS rating for processors within the same partition. For example, the MIPS rating of 900 MIPS for eight IPs refers to the maximum performance level obtained when all eight IPs are allocated to the same partition. As discussed above, however, processors need not be allocated to a single partition. For example, eight IPs may instead be allocated to two partitions, each including four IPs running within the same sub-POD. In this case, the MIPS rating for each partition is obtained from the third table entry, which lists a single partition including four IPs as being rated at 630 MIPS. Thus, two partitions of four processors provide a total of 1260 MIPS, which is higher than the 900 MIPS obtained from the single-partition configuration.

The table of FIG. 4A may be used to scale the maximum system performance to a predetermined ceiling level as follows. Assume that a customer has a system similar to that shown in FIG. 1, but which includes only two sub-PODs 50. Each sub-POD is populated by four IPs 80 for a total of eight IPs in the system. Further assume the ceiling level of an authorization key is set to 450-MIPS as discussed above in reference to FIG. 3A. The customer is allowed to utilize as many of the available IPs as desired to perform day-to-day processing tasks, but the total performance will not be allowed to exceed the ceiling level of 450 MIPS.

In the current example, assume that the customer chooses to deploy all eight IPs in the same partition. The customer may desire to employ this “eight-way” single partition configuration because it provides the best response times when multiple users are submitting requests within a transaction-processing environment. As illustrated by the fifth entry of FIG. 4A, this type of configuration has a rated maximum performance of 900 MIPS. Since the customer's ceiling is set at 450 MIPS, the maximum performance level the system will be allowed to achieve is 450/900, or 50 percent. Thus, when processing levels increase to the point wherein each IP is performing useful work 50 percent of the time, the processing of each IP will be throttled. Each IP will be forced to an idle state 50 percent of the time in the manner discussed above.

Assume next that the customer wants to change the system configuration. This may be desirable to transition from the transaction-processing environment discussed above to a batch mode environment wherein system-critical tasks are processed in a serial manner. By their nature, some of these system-critical tasks are single-threaded and must be executed consecutively. To better accommodate these types of tasks, five of the eight processors that were running in the partition are disabled, or “downed”. Only three IPs remain executing within the partition.

From the second entry of FIG. 4A it can be seen that the maximum performance level of this “three-way” partition is 500 MIPS. At a ceiling performance level of 450 MIPS, the system performance will be scaled by a factor of 450/500, or 90 percent. Therefore, each IP will not be allowed to exceed a performance level of 90 percent. To accomplish this, the IP will be forced into an idle state 10 percent of the time. When the batch mode tasks have completed, the remaining five IPs may be re-enabled to again provide the transaction-processing configuration that is more suitable for a multi-user environment. At that time, the ceiling level will again be set to 50 percent processing power for each of the IPs.

It may be noted that in reality, processors are enabled and disabled individually, so the system's ceiling performance level changes incrementally as the transition from an 8-way to a 3-way configuration occurs, and vice versa.

The above example involves a ceiling level for a single partition. Similar considerations are employed when scaling the ceiling performance level in a scenario involving multiple partitions. For instance, assume that the customer of the current example wants to utilize the key having a 450 MIPS ceiling level for a system that is executing multiple partitions. Recall that the customer has a system similar to that of FIG. 1 that includes two sub-PODs, each populated with four IPs. Further assume that in the system of FIG. 1, partitions can only be created on sub-POD boundaries. Therefore, the customer may utilize a configuration having, at most, two partitions, each including a sub-POD populated by four IPs.

Next, assume that the customer desires to run an important application in a first partition while the less critical applications execute in the other partition. To ensure that sufficient processing power is available for the critical task, the customer chooses to allocate 300 of the 450 MIPS to limit the ceiling of the first partition. In one embodiment, this type of allocation may be performed by an operator using a predetermined operations or administration screen available on system console 95. This type of allocation may be subject to limits imposed by the system administrator. Alternatively, the allocation may occur when the OS is booted and reads performance data from a predetermined location in main memory, as discussed below.

After a performance level has been allocated to a partition, scaling factors may be calculated. For example, assume that all four IPs in the first partition are enabled. The maximum rated performance of the first partition is therefore 630 MIPS, as shown in the third entry of FIG. 4A. Thus, SCPF 90 must scale the maximum performance level of each IP in the first partition by a factor of 300/630, or 48 percent. That is, IPs of the first partition are allowed to attain a maximum of a 48 percent performance level.

Next, the remaining 156 MIPS that have not been allocated to the first: partition are automatically allotted to the ceiling of the second partition. Assume that in this other partition, three IPs are enabled. This partition therefore has a maximum rated performance of 500 MIPS. SCPF 90 scales the performance level of the partition to 150/500, or 30 percent. Thus, the performance of each IP is scaled such that no IP achieves greater than 30 percent of its maximum processing potential.

As can be appreciated by the foregoing examples, the current system and method allows IP performance levels to vary between partitions. For instance, the IPs of the first partition may execute at up to 48 percent of their maximum performance level, whereas the IPs in the other partition may only execute up to 30 percent of their maximum capacity.

In one embodiment, in addition to varying the ceiling levels between partitions, it is also possible to varying the ceiling levels of IPs within the same partition. However, because the IPs of a given partition are operating on the same tasks and may be sharing and/or passing data through shared memory in MSU 10, processing power is generally most efficiently utilized by distributing it evenly between the IPs of the same partition. For this reason, in one embodiment, all IPs within the same partition are scaled by the same scaling factor.

According to one embodiment of the invention, warning messages may be provided if a partition cannot achieve a desired performance level. For example, if a user or an automated process attempts to set a ceiling at 600 MIPS for a partition having 3 IPs in one sub-POD, a warning message will be provided indicating the maximum processing power that may be achieved by this partition is 500 MIPS. In such situations, SCPF 90 will allow each IP in the partition to execute at 100 percent, and all remaining MIPS will be available for allocation to a ceiling of one or more other partitions.

According to another aspect of the system, a warning message will be issued if the performance level of an IP is scaled below a predetermined minimum value. This warning is provided because, in one embodiment, the forced idling mechanism does not operate in a predictable manner when an IP is scaled below a certain performance level. In addition to the warning, SCPF 90 will “down” one or more processors until the remaining processors are executing at, or above, the predetermined minimum processing level. For example, if the customer attempts to run eight IPs in a partition with a ceiling level of 20 MIPS, SCPF will continue downing IPs until the remaining IPs in the partition are running at a scaled performance level that is above the minimum level. This will allow the 20 MIPS to be predictably supported.

FIG. 4B is a block diagram illustrating one embodiment of a system for assigning performance-based ceiling levels in the manner discussed above. An authorization key 400 is provided to the user on a tape, an email transmission, disk, or via some other medium. This key may be uniquely identified by a key identification field 402. The key may further include a system identification field 404 that stores a serial number or other identification data associating the key with the system on which it will be utilized. Finally, the key stores an available performance level 406, and any time limitations 408 associated with the key such as expiration date and maximum time of use.

The authorization key is registered with the system using a software utility that tracks licensing data, shown as licensing registration software 410. This software verifies that the data stored within system id field 404 of the key matches identification data 412 provided with the system. Such system identification data may be stored within a read-only memory or some other storage device, may be hardwired on a back panel, manually or automatically selected using switches, or provided in any other suitable way.

Key information may also be copied to memory available to system control software 96, as illustrated by key data 414, such as memory within system console 95 of FIG. 1. In one embodiment, system control software may retain information describing more than one authorization key. This may be desirable, for example, if a customer purchases both normal and optional keys that are both registered on the same data processing system.

Next, system control software 96 may be used to create one or more processing partitions. Specifically, an operator may employ maintenance screens provided by system control software to select the hardware that is to be added to a given partition. In response to this selection, system control software 96 employs scan interface 97 to enable and/or disable the appropriate hardware interfaces, including memory, cache, and processor interfaces. This electrically isolates the hardware of one partition from another, while allowing the various IPs, caches, and memories of the same partition to function as a unit. IPs that are included within a partition are enabled to communicate with their respective shared cache, whereas IPs that are not being used are electrically isolated from their respective shared cache and are not executing until such time as they are enabled. As discussed above, in one embodiment, the hardware of FIG. 1 must be partitioned on sub-POD boundaries. That is, hardware from the same sub-POD may not be included within two different partitions.

After system control software 96 configures hardware and allocates one or more memory ranges within MSU 10 to a partition such as partition A 420, an instance of the OS 85 is booted within the allocated memory range(s). For example, an instance of the operating system, shown as OS A, 85A, is booted in partition A 420. In this embodiment, OS A includes as part of its kernel an instance of SCPF, shown as SCPF A, 90A. The partition also includes at least one IP 80A, which has a quantum timer 81A that is used to facilitate multitasking.

Sometime before or after the OS is booted, key information 418 including the maximum available performance level provided by the performance key is copied to partition A memory 416. Partition A memory is a range of memory within MSU that is directly accessible to partition A. OS A will read the key information from a known location within partition A memory to obtain the performance level provided by the registered key.

In one embodiment, the OS will, by default, attempt to obtain the entire performance level of the key. For example, if the key provides a maximum performance level of 450 MIPS, SCPF A included within OS A 85A will attempt to obtain the entire 450 MIPS. SCPF A then issues a message to system control software 96 indicating that the entire 450 MIPS has been obtained. If the entire 450 MIPS was available for allocation, system control software 96 updates the authorization key data 414 to record that partition A is executing at a performance level of 450 MIPS. OS A then notifies SCPF A that the performance level is allowable. SCPF A will thereafter scale performance of the IPs within the partition to achieve this performance level, as will be discussed further below.

In a manner similar to that described above, an operator may utilize system control software 96 to create an additional partition B 430. Memory within MSU 100 that is accessible to this partition is shown as partition B memory 421. Sometime before or after an instance of the OS is booted within partition B, key information 419 is copied to partition B memory. This key information includes the maximum available performance level 406 provided by the key.

An instance of the OS, shown as OS B, 85B, is booted in this additional partition B. OS B reads the key information 419 from partition B memory 421 and attempts to obtain all of the 450 MIPS provided by the key. SCPF B, 90B, issues a message to system control software 96 indicating that partition B is currently set to a performance level of 450 MIPS. System control software 96 utilizes key information 414 to determine that 450 MIPS have already been allocated to partition A 420. System control software returns an error message indicating that no MIPS are available for use, and partition B will be halted.

The foregoing discusses one embodiment wherein an OS always attempts to obtain all available MIPS provided by the authorization key upon completing the boot process. In this embodiment, some type of intervention is required to allow multiple partitions to be employed. For example, according to one aspect, OS A provides a display screen on system console 95 that is available to an operator for entering performance data. The operator may utilize this screen to send a message to SCPF A, 90A, indicating that partition A is to operate at something less than the entire 450 MIPS. Any time after OS A is booted, for instance, the operator may send a message to SCPF A indicating that partition A is to run at 200 MIPS. Upon receipt of this message, SCPF A stores this performance data within key information 418, and modifies performance of the partition accordingly. In addition, SCPF A sends a message to system control software 96 indicating the performance level of partition A has been modified, and system control software 96 updates the authorization key data 414 to reflect that partition A is now running at 200 MIPS.

Next, assume that partition B is created and OS B 85B attempts to obtain all 450 MIPS. OS B issues a message to system control software 96, which determines that only 250 MIPS of the 450 MIPS are available for use. System control software records that 250 MIPS are being allocated to partition B, and returns a message to OS B indicating that partition B must run at 250 MIPS. SCPF B records that partition B will execute at 250 MIPS, and thereafter scales performance of the IPs in the partition to achieve this performance level.

SCPF A has access to one or more performance data tables 440 stored within partition A memory 416. Similarly, SCPF B has access to one or more performance data tables 442 residing within partition B memory 421. These tables, which are similar to that shown in FIG. 4A, store data that is specific to the configuration, and which is used to scale IP execution in the manner discussed herein.

System configurations and performance level allocations may be changed, as discussed above. For example, an operator may change the amount of processing power that is allocated to a given partition, so long as the total processing power used by all partitions does not exceed the maximum performance level specified by the registered key. Similarly, an operator may change the configuration of a partition by enabling or disabling IPs in a sub-POD included within the partition. When either of these events occurs, SCPF re-calculates the amount of time each IP must spend in a forced idle loop to achieve the allocated performance level for the partition.

The above examples describe one embodiment wherein the instance of SCPF included within an OS attempts to obtain all processing power provided by an authorization key when the OS is booted. In another embodiment, performance data may be stored with key information to cause SCPF to attempt to obtain a different performance level. For example, performance information may be stored within key information 418 of partition A memory 416 indicating that partition A should optimally obtain 200 MIPS. When OS A is booted, SCPF A will read this key information from memory 416, and will attempt to obtain the optimal performance level of 200 MIPS. A message will be issued to system control software 414, and system control software will determine whether this performance level is available for allocation in the manner discussed above. If this performance level is not available, system control software 96 will return a message to SCPF A that specifies the performance level that is available. SCPF A will set the performance of the partition to this available level.

In one embodiment, key information 418 will include the minimum performance level that is desired for optimal operation of the partition. This minimum performance level, which is configured by the customer, specifies the minimum level of performance that must be allocated to the partition to allow that partition to continue completing processing tasks in an optimal manner. For example, it may be beneficial to assign this type of minimum performance level to a partition that is performing high-priority work as a guarantee that enough processing power is available within the partition to allow the work to complete in a timely manner. If this type of minimum performance level has been assigned to a partition, and if system control software 96 returns a message to partition A indicating the performance level available to that partition is less than this assigned minimum performance level, the SCPF will issue periodic warning messages to the system operator. These messages will be provided to a display screen on system console 95 to warn the operator that the partition is not running at the optimal level.

The foregoing discussion describes situations wherein the authorization keys are registered before partitions are created and the OS instances are booted. In another embodiment, this is not a requirement. In a scenario wherein a key is registered after partition creation, the partition will stop executing if a key is not registered within a certain period of time thereafter. When the key is registered, key information is copied to memory accessible by each partition, such as key information 418 for partition A, and key information 419 for partition B. A message is issued to the SCPF of each partition, which will then set the performance level of its partition using the key information and information provided by system control software 96 in the manner discussed above.

FIG. 4C is a block diagram illustrating yet another embodiment of the current invention. Elements similar to those shown in FIG. 4B are assigned like numeric designators. In this embodiment, SCPF 90C is incorporated within system control software 96 rather than being included within the kernel of the OS. Additionally, all key information 414 and the one or more performance data tables 444 are retained within memory that is accessible to SCPF 90C, but which is not directly accessible by any created partition.

The system of FIG. 4C operates in a manner similar to that discussed above. An operator creates a partition using system control software 96. Next, the operator may employ a screen provided by SCPF 90C on system console 95 to allocate a performance level to the newly created partition. If this performance level is not allowed for reasons set forth above, SCPF provides the operator with a warning message indicating, for example, that the specified performance level exceeds the level remaining on the key. When an acceptable performance level has been selected for a partition, SCPF 90C stores this performance allocation in authorization key information 414. SCPF records all allocations made for each partition associated with the key.

After a partition is configured, SCPF 90C tracks processing time for each IP in a manner similar to that performed by SCPF 90A and 90B. In this embodiment, SCPF 90C controls the performance level of each partition by informing an SCPF agent included within the partition's OS to enforce the allocated performance level for the partition. This agent then scales the performance of each of the IPs in the partition appropriately. The manner in which IP performance is scaled is discussed further below.

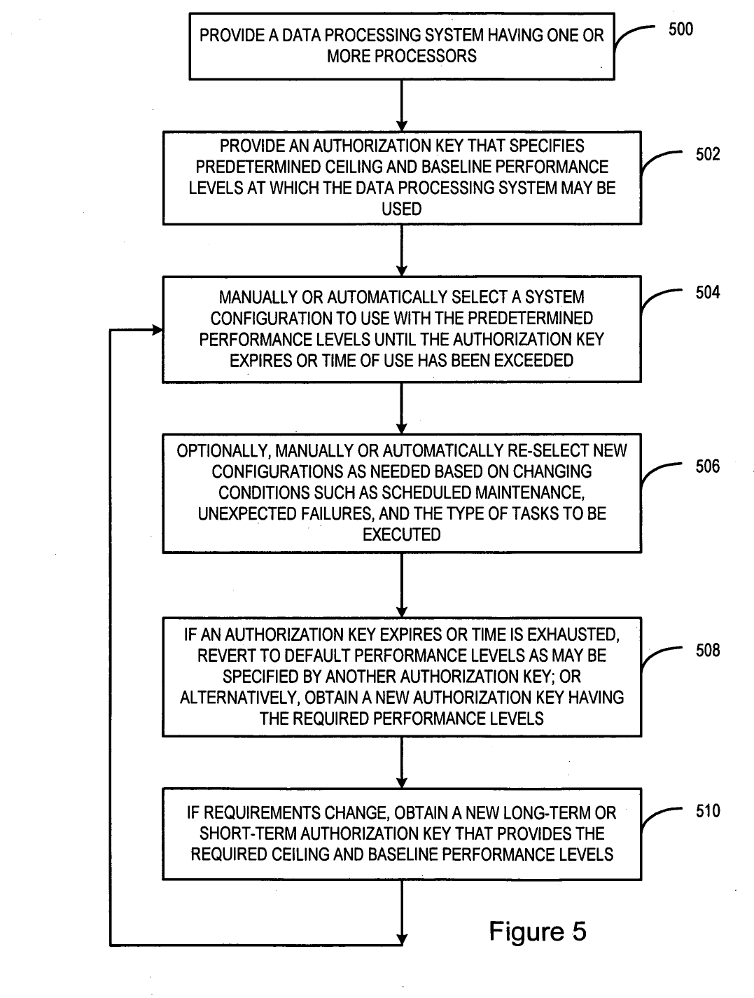

FIG. 5 is a flow diagram illustrating one embodiment of a method according to the current invention. A data processing system is provided that includes one or more IPs (500). The customer obtains an authorization key that specifies predetermined ceiling and baseline performance levels for the data processing system (502). In one exemplary embodiment, the level of performance is specified in MIPS. However, it will be understood the performance level may be described using any other suitable metric.

The authorization key may be a normal key that is to be used for a long time period, or may be an optional key that is generally used for a short period of time. In one embodiment, the performance key may be delivered with the system. For example, the key may be registered on the system before the system is delivered. In another embodiment, the performance key may be provided to the customer after the system has been installed at the customer site. The performance key may be provided to the customer on a tape, disk, via an email transmission, or using any other suitable mechanism. The customer will register the key on the system and any system identification provided with the key will be verified during the registration process in the manner discussed above.

The customer may select a system configuration to use with the predetermined performance levels (504). This may be accomplished using system control software 96. In general, any one of multiple configurations will be available for use with the performance levels. The customer may select the desired configuration based on the type of processing tasks that will be executed on the data processing system, for example. At any time, the customer may re-select a new configuration based on changing conditions (506). These conditions may include the scheduling of system maintenance, the occurrence of unexpected failures, or a change in the type of processing tasks to be executed on the system. If desired, the configuration may be modified automatically. For example, this could be accomplished using functionality embodied within software executing on system console 95.

In one embodiment, a console program such as the Single Point of Operations console application commercially available from Unisys Corporation may be used to automatically select or modify the configuration. This type of automated configuration modification may occur at predetermined times of the day or based on monitored system conditions. For instance, one configuration may be selected for executing processing tasks in batch mode during the evening, whereas a second configuration may be selected to support a transaction—processing environment during the workday.

If an authorization key expires, or the time associated with the key is exhausted, the ceiling and baseline performance levels may transition to default values such as the performance levels that are specified by a different key (508). For example, if a long-term key has been registered with the system at the time a short-term key expires, the system may transition to performance levels specified by that long-term key. This transition may occur automatically under the control of SCPF 90 and system control software, or may be performed manually by the customer after a warning message has been issued regarding the termination of the optional key. In one embodiment, if another key has not been registered on the system when key expiration occurs, system execution will halt until the customer obtains another key.

The customer may also obtain a different key when performance requirements change (510). This key may be a long-term or short-term key, and may provide increased or decreased performance levels as compared to the previous key, depending on the changing requirements of the customer. Using this new key, the customer may select a system configuration to use with the predetermined performance level specified by the new key (504), and the process may be repeated.

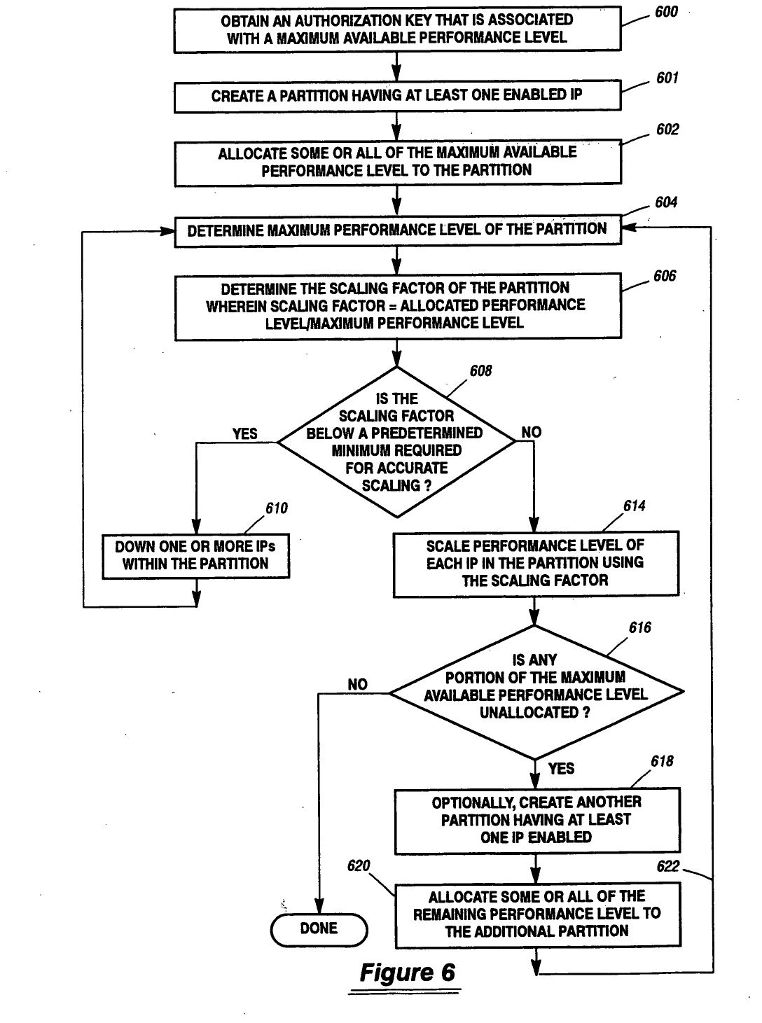

FIG. 6 is a flow diagram illustrating one embodiment of a method of allocating the ceiling performance levels to one or more partitions in the manner discussed above. This method may be performed using system control software 96 in conjunction with SCPF 90, as discussed in reference to FIGS. 4B and 4C.

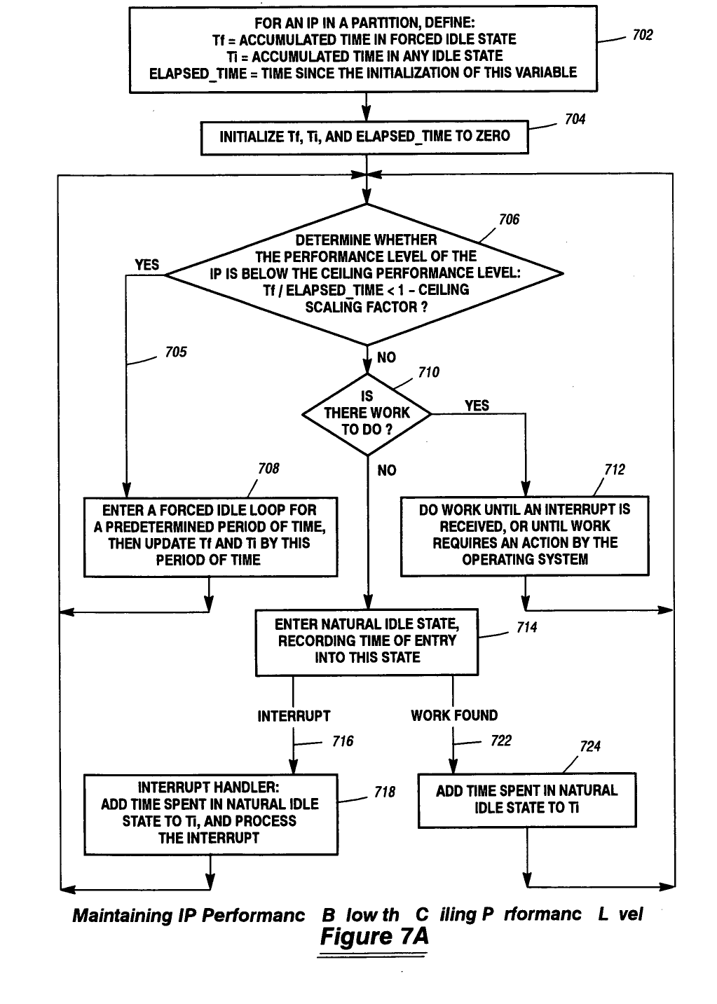

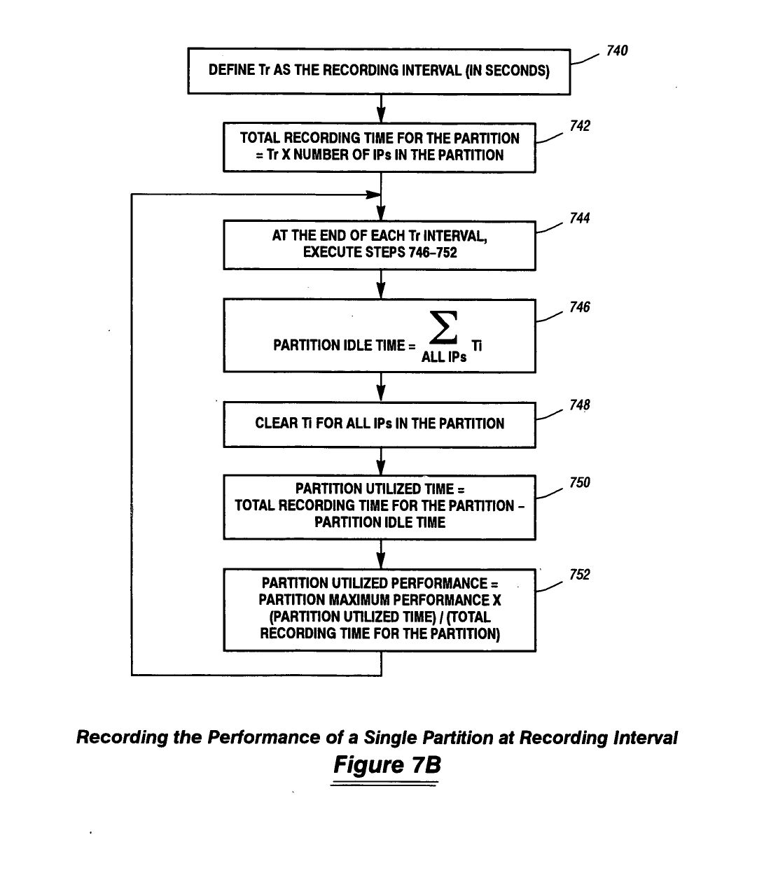

According to the method, a ceiling, or “maximum available”, performance level is obtained by purchasing an authorization key (600). This performance level may be specified in MIPS or in some other unit of measure that is suitable for describing the performance of a data processing system. A partition is created having at least one enabled IP (600). Some or all of the ceiling performance level is allocated to the partition (602). The configuration of the partition, including the number and location of the enabled IPs, is then used to determine the maximum possible performance of the partition (604). This can be accomplished using one or more tables such as the table shown in FIG. 4A. A scaling factor may then be calculated for the ceiling performance level of the partition (606), as follows:
Ceiling scaling factor (allocated performance)/(maximum performance level of the partition).
The ceiling scaling factor is used to scale the maximum performance of the IPs within the partition, as discussed in regards to FIG. 7A.

Next, it may optionally be determined whether the scaling factor is below a predetermined minimum level (608). As discussed above, in some systems, accurate performance scaling cannot be performed if an IP is running below a predetermined minimum performance level. In one embodiment, the predetermined minimum level used during this verification step may be programmably selected.

If the scaling factor is below a predetermined minimum value, one or more IPs may be disabled within the partition (610). A new scaling factor is derived by again consulting the look-up table to determine the new maximum performance level of the partition, then calculating the new scaling value, as shown in steps 604 and 606. If the scaling factor is again below the predetermined minimum level (608), the process is repeated until the scaling factor exceeds the minimum value. The scaling factor may then be used to scale performance of each IP in the partition (614).

If any portion of the ceiling performance level specified by the authorization key is unused (616), the user may optionally create another partition having at least one IP (618). Some or all of the remaining ceiling performance level may be allocated to the additional partition, and the process may be repeated, as shown by arrow 622. In one embodiment, if the user creates a partition that is not assigned a specific ceiling performance level, SCPF 90 will automatically allocate all of the remaining ceiling performance level to that partition. The process of FIG. 6 may be repeated for more than two partitions, so long as the sum of the ceiling performance levels allocated to all partitions does not exceed the maximum performance level provided by the authorization key.

The foregoing discusses the manner in which the ceiling performance level is allocated to partitions. The following describes how the allocated performance levels are utilized to throttle the processing of an IP, and to obtain a billing amount to provide to a customer.

FIG. 7A is a flow diagram of one embodiment of scaling and monitoring the performance level of an IP in a partition according to the current invention. The scaling operation may be controlled by SCPF 90 or some other entity in any of the ways discussed above.

First, two accumulators, Tf and Ti, are defined for the IP (702). Tf accumulates time that is spent in the forced idle state, and is used to keep the performance of the IP below the ceiling performance level. Ti accumulates all idle time for the IP, including forced idle and natural idle times, and is used in calculating the utilized performance of the partition, as will be described in FIG. 7B. Another variable called “elapsed_time” is defined to store the time that has elapsed since the start of metering. When metering is initiated, the Tf and Ti accumulators are cleared, and the elapsed_time is set to zero (704). Thereafter, SCPF records the passage of time in the variable elapsed_time using the system clock as the reference.

Next, a process referred to as a “dispatcher” is engaged. The dispatcher is a process that allocates the processing resources of an IP to tasks that are queued for execution, usually according to a priority mechanism. The details associated with task prioritization is beyond the scope of the invention. It is only important to appreciate that the dispatcher regards the processing of tasks as “work”, and the absence of eligible tasks as “natural idle”.

When the dispatcher is determining whether work is available to be processed, it must first check to make sure that the IP's performance level is being kept below the purchased ceiling performance level (706). To do this, the dispatcher determines whether the portion of time spent in a forced idle state thus far during the elapsed time period is less than that dictated by the ceiling scaling factor, as follows:
Tf/elasped time<1−ceiling scaling factor ?
If accumulator Tf indicates that not enough time has been spent in the forced idle state (705), the IP enters the forced idle state, repeatedly using the system clock to update Tf and Ti (708). The process periodically returns to step 706 to check Tf against the ceiling scaling factor, and the process is repeated until sufficient time has been spent in the forced idle state.

Once sufficient forced idle state Tf has been accumulated, the IP determines whether there is any work to be performed (710). If one or more tasks are awaiting execution, a task is selected and the task's execution environment is established. After a task is identified for execution, various IP registers must be initialized using environment data stored when the task was last executed by the IP. As is known in the art, this type of data may be stored within a stack entry or some other storage structure in memory. If this is not a trusted system task, the IP's quantum timer is initialized for use in interrupting the task, if necessary, to ensure that control will be returned to the OS after a maximum quantum of time allotted to the task has expired. The IP proceeds to execute the task's instructions. The task will be executed until it requires some service from the OS, the task completes, or an interrupt occurs. Such an interrupt may be received because of expiry of the quantum timer or the completion of an input/output (I/O) request (712). Any of these events may result in the same or other tasks being queued for execution. Eventually, the IP will return to the dispatcher, looking again for the highest priority work to process (706), and the sequence is repeated.

Returning to step 710, if there are no tasks awaiting execution, the IP enters the natural idle state (714). The time at which this state is entered is recorded for later use. While in this state, the IP executes an instruction sequence that has minimal effect on the efficiency of the rest of the system's components. The IP is able to detect hardware interrupts, such as the completion of an I/O request. The IP can also detect whether work is available for processing. Time spent in the idle state is not regarded as utilization of the IP.

If a hardware interrupt occurs, as indicated by arrow 716, the interrupt handler determines whether the IP had been in the natural idle state. If so, the time spent in this state is added to the accumulator Ti (718). The interrupt handler processes the interrupt, possibly queuing a task for execution.

Next, the IP returns to the dispatcher, as indicated by arrow 720. The IP will determine whether any forced idle is required to keep performance below the ceiling, before it selects any task for execution, and the process is repeated.

Returning to step 714, if the IP is in natural idle state and determines that work has become available for processing, as indicated by arrow 722, the time spent in the natural idle state is added to accumulator Ti (724). The IP returns to the dispatcher to determine whether any forced idle is required so that the performance level is maintained below the ceiling (706).

As mentioned above, FIG. 7A illustrates the process employed by an IP to accumulate time spent in any idle state, Ti. This indicates when the performance of an IP is not being utilized. Periodically, the Ti accumulators for all IPs within a partition are monitored to determine the utilization of the partition. This is described in reference to FIG. 7B.

The foregoing process is described as being performed on a single IP. It will be understood that this process is likewise performed for each IP within a partition. That is, respective variables Ti, Tf, and elapsed_time are defined for each IP within the partition. Idle time is accumulated individually for an IP based on that IP's processing activities.

FIG. 7B is a diagram illustrating a process for determining the utilization of a partition. This process may be performed by SCPF 90, or another software entity. First, a recording interval, Tr, is defined (740). This interval may be a fixed time period determined in advance by the system provider, or may be a variable parameter that is controlled by the performance key delivered to the customer or controlled in some other mechanism. In the current embodiment, the recording interval Tr is set to one minute. Other intervals may be utilized in the alternative.

After defining the recording interval, Tr, the total recording time may be calculated as follows (742):
Total recording time for the partition=Tr×(number of processors in the partition).
These values are used to record the performance of a partition as follows.

Upon expiration of each Tr interval (744), the Ti accumulators for all IPs in the partition are added to get a total idle time for the partition (746). Next, accumulators for all of the IPs in the partition are cleared (748). The total utilized time for the partition is then calculated as follows (750):
utilized time for the partition=total recording time−total idle time.

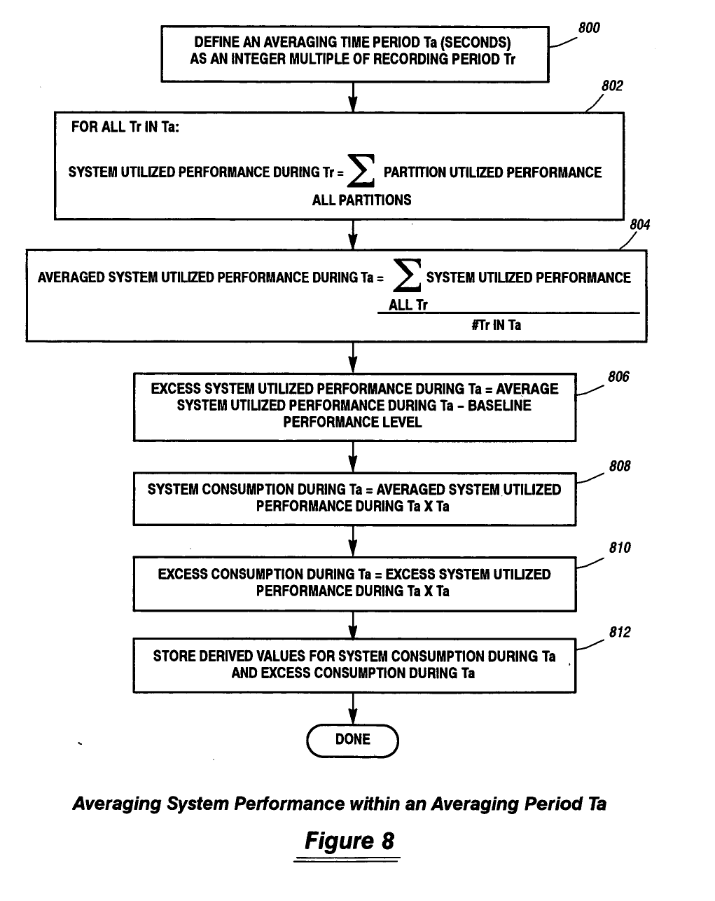

The maximum performance of the partition, which is obtained from the configuration table in FIG. 4A, is then multiplied by the ratio of utilized time for the partition over total recording time, as follows:
Partition utilized performance=partition maximum performance×(utilized time for the partition/total recording time).
This provides the utilized performance for the partition (752). For example, if the configuration were rated at 300 MIPS and the partition was idle for 20% of the time, then utilized performance for the partition over the time Tr would be 300 MIPS×0.8, or 240 MIPS. The utilized performance for the partition is recorded and time-stamped for use, as discussed below in FIG. 8.

FIG. 8 is a flow diagram describing the manner in which the utilization times for all partitions controlled by a single partitionable key are averaged. This process may be performed by SCPF 90, or another software entity residing within MSU 10 or some other memory included in, or coupled to, the system of FIG. 1. Alternatively, this process may be performed by a software entity residing on billing authority system 98, or another system coupled to the system of FIG. 1.

In FIG. 8, the utilization times for all partitions controlled by a single partitionable, metered key are accumulated and averaged over a period of time Ta. Ta may be any integer multiple of the recording period (800). In the preferred embodiment the recording period and the averaging period are the same, but this relationship may be changed to reflect the system provider's financial arrangements with its customers. For example, it may be noted that the customer is billed for the utilization “peaks” that exceed a baseline. A longer averaging period will tend to smooth out the utilization peaks and valleys, resulting in a lower excess utilization over a typical business day in a manner that is favorable to the customer. Therefore, competition among system providers may result in a lengthened averaging period. In this case, it may still be beneficial to maintain a shorter recording period so that the system provider may monitor the financial effects of the longer averaging period. This arrangement will result in a time period Ta that will be an integer multiple of the recording period.

Returning to the process of FIG. 8, for each time period Tr within Ta, the system utilized performance is calculated. That is, for each time period Tr, the utilization of each of the partitions within the system during that time period are added (802). The utilized performance of the system is then averaged over the averaging period Ta (804). This is accomplished by adding the system utilized performance values for each time period Tr included within the averaging period, then dividing by the number of time periods Tr within the averaging period Ta as follows:
Averaged system utilized performance=(Σ system utilized performance for each time period Tr in Ta)/(Number of time periods Tr in Ta)

The resulting averaged system utilized performance is expressed in MIPS or some other comparable unit of measure. This value may be used to calculate excess system utilized performance, which is defined as the amount the averaged system utilized performance exceeds the baseline performance level during Ta (806). If the averaged system utilized performance does not exceed the baseline performance level, the excess system utilized performance is recorded as being zero.

Next, metrics involving processing consumption are derived. Consumption is described in units of “Performance Level×Time”, such as “MIPS-Seconds”. As may be appreciated, consumption is derived by multiplying a utilized performance level by a period of time. To determine the system consumption during averaging time period Ta, the averaged system utilized performance is multiple by time Ta (808). Similarly, excess consumption during time Ta is derived by multiplying excess system utilized performance by time period Ta (810).

In the preferred embodiment, the customer is to be billed for excess consumption during any of the averaging periods. In other embodiments, the customer may be billed for average consumption rather than the peaks exceeding the baseline. In this case, it may be sufficient to monitor system consumption without regard to excess consumption.

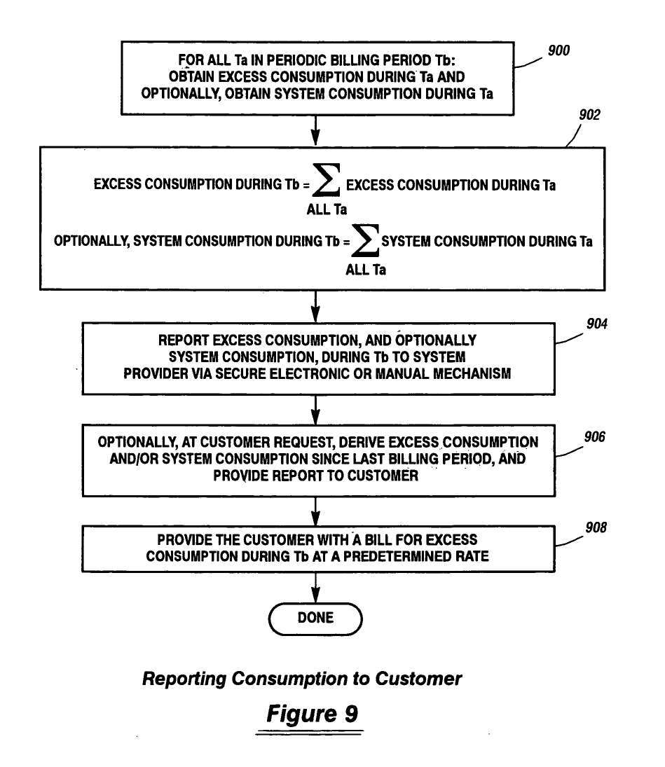

One or both of the consumption calculations are recorded for later use (812). In one embodiment, these values are recorded in protected memory or some other storage device residing at the customer's location, the system provider's site, or any other suitable place that cannot be write-accessed by the customer. The manner in which these values are used is discussed below in reference to FIG. 9.

The embodiment described in reference to FIG. 8 discusses an arrangement wherein the entire system is controlled by a single partitionable metered key. The customer may choose to use this key for a single partition, or subdivide the system into multiple partitions. In the latter case, the metering process accumulates the performance utilization from multiple partitions, using the time-stamps to ensure that the figures are synchronized, as shown in step 802 of FIG. 8. Alternatives to this embodiment are possible. For example, the system provider may decide to offer certain workload environments at different prices. In one scenario, a customer may purchase a production key to be used during the execution of day-to-day processing tasks, and a development key that is used for the development of software. The production key may be purchased at full price, whereas the development key may be obtained at a discounted price. Each of these keys may be partitioned.

In the foregoing scenario wherein two keys are used on the same system, the metering process of FIG. 8 is performed for each key separately based on the utilization measurements obtained for the partitions that are associated with the key. Separate consumption calculations are reported to a billing authority for each key so that respective financial calculations may be derived. In another example, the process could be extended to cover all of the systems included within a family or a cluster at the customer's installation.

FIG. 9 describes the reporting of consumption metrics to the customer and to the system provider's billing authority. As discussed above in reference to FIG. 8, excess consumption, and optionally, system consumption, metrics are recorded and time-stamped for each averaging time period Ta. At the end of a predetermined billing period, Th, the excess consumption values, and optionally, the system consumption values that were recorded during any time period Ta included within Tb will be obtained for billing purposes (900). In the preferred embodiment, the billing period Th is one month, but it could instead be defined as one week, two weeks, a quarter, or any other convenient time period. In other embodiments, reporting could occur in real time, as often as the consumption metrics are recorded (Tr), or at any other multiple of Tr, in order for the billing authority to have a more current view of potential revenue.

Next, the excess consumption values for all time periods Ta included within time period Th are added to obtain the total excess consumption during time period Tb (902). Optionally, system consumption for all time periods Ta may be added to obtain system performance for time period Tb. This excess consumption, and optionally, system consumption, are reported to the system provider's billing authority via some secure electronic or manual process (904). For example, it could be transferred over a network 100 (FIG. 1) such as the Internet using encryption technology. This data could then be retained on billing authority system 98. In another embodiment, the transfer could occur manually. For instance, the customer could send the data on a tape, disk, or some other suitable medium. In still another embodiment, the unprocessed recorded values may be transferred to the provider for calculation of the performance consumption by billing software 99.

Optionally, the customer may request a report on the excess consumption used thus far during a current billing period time. The customer will receive a report based on the sum of all excess consumption recordings since expiration of the last billing period (906). The customer can also review, but not alter, the detailed records that were used to generate the report.

The billing authority provides the customer with a bill for the excess consumption at some predetermined rate. This bill may be generated by billing software 99 (FIG. 1), for example. The rate is expressed in “Dollars/(MIPS−Seconds)” or a similar unit (908). In another embodiment, the customer may be billed for the system consumption occurring during time Th, rather than the excess consumption.

The foregoing approach may be used to scale performance levels on a short-term, or a more long-term, basis. According to one embodiment, the customer is allowed to lower the ceiling performance level at any time during the billing period. This change may be programmably selected by the customer, or may be updated by the service provider upon customer request. The next billing period will include any necessary charges for the modified performance level. After activation, the new performance level is used to monitor system performance for billing purposes in the manner discussed above. After the ceiling performance level is lowered, the customer may choose to raise it to any level up to that which was originally specified by the key.

In a similar embodiment, the customer may also change baseline levels during the billing period. However, since baseline levels are pre-paid and recorded in the performance key, this would involve issuing the customer a new performance key and billing the customer at the time a baseline level is increased on a prorated basis that takes into account the time remaining in the billing cycle.

In one embodiment, the monitoring and averaging methods illustrated in FIGS. 6 through 8 may be utilized without ceiling and/or baseline levels. That is, the baseline level may be set to zero, and/or the ceiling level may be set to 100 percent of the configuration's maximum performance. If a baseline level is set to zero, the customer is not pre-charged for any processing time, and instead is on a strictly “pay-as-you” go plan. If a ceiling level is set to 100 percent, IP performance is not throttled.

According to another embodiment, the monitoring method of FIGS. 7A and 7B may be used to obtain statistics on system usage in addition to, or instead of, being employed for deriving billing data.

Although the preferred embodiment discussed above utilizes performance-based keys to implement the ceiling and baseline performance levels, this is not required. In another embodiment, the performance levels could be specified by providing information similar to that illustrated in the keys of FIGS. 2A and 2B, above. For example, a key could specify a baseline level utilizing any four processors running at fifty percent, and a ceiling level using any four processors executing at eighty percent. In a similar embodiment, the key identifies specific IPs for use, rather than allowing the customer to identify the IPs that will be enabled. In these alternative embodiments, the scaling factors are not obtained by allocating performance levels to partitions, as shown in FIG. 6. Instead, the scaling factors for the baseline and ceiling are those provided in the key. In the foregoing example, these scaling factors would be fifty and eighty percent, respectively. Metering can be accomplished using these scaling factors in a manner similar to that shown in FIGS. 6 through 9. It will be recognized that these embodiments have some of the limitations discussed above in reference to FIGS. 2A and 2B, however. For instance, these configurations do not take into account performance characteristics associated with a chosen configuration. Additionally, these embodiments do not allow for system re-configuration as needed to accommodate failures or adjust for workload types.

Having thus described the preferred embodiments of the present invention, those of skill in the art will readily appreciate that the teachings found herein may be applied to yet other embodiments. For example, the type of data processing system described and illustrated herein will be understood to be merely exemplary, and any other type of data processing system may be used in the alternative. Additionally, although the metering techniques described above are discussed in reference to instruction processors, they could be applied to I/O processors as well. In yet another embodiment, the model employed for charging customers could be modified. For example, in an alternative embodiment, customers may be charged for utilized performance at predetermined time increments, rather than being billed for consumption. Thus, the embodiments presented herein are to be considered exemplary only, and the scope of the invention is indicated only by the claims that follow rather than by the foregoing description.

1. A method of metering performance of a data processing system, comprising:
monitoring the performance of the data processing system; and
charging a customer based on utilized performance that exceeds a baseline performance level.

2. The method of claim 1, wherein the baseline performance level is zero.

3. The method of claim 1, and further including allowing the customer to pre-pay for the baseline performance level.

4. The method of claim 1, and further including:
recording information for deriving the utilized performance; and
billing the customer based on the utilized performance averaged over a predetermined period of time and the predetermined period of time.

5. The method of claim 4, and further including allowing the customer to access the recorded information.

6. The method of claim 4, and further including periodically transferring the recorded information to a billing authority.

7. The method of claim 3, and further including limiting the performance of the data processing system to no more than a ceiling performance level.

8. The method of claim 7, and further including providing an authorization key for use with the data processing system that specifies at least one of the baseline performance level and the ceiling performance level.

9. The method of claim 7, wherein the data processing system may be configured in any of multiple configurations, each including at least one enabled processor, and further including:
configuring the data processing system in a selected one of the configurations;
determining the maximum performance level of the selected configuration;
deriving a scaling factor=(the ceiling performance level)/(the maximum performance level); and
scaling the performance of each of the enabled processors by the scaling factor.

10. The method of claim 9, wherein the scaling step is performed by forcing each of the enabled processors in the selected configuration to an idle state for a predetermined percentage of time determined by the scaling factor.

11. The method of claim 9, wherein a predetermined time interval is selected as a recording period, and further including performing the following steps during each of one or more of the recoding periods:
for each of the enabled processors, recording idle time wherein work is not being performed by the processor; and
calculating a utilized performance level for the recording period based on the maximum performance level of the selected configuration and the idle time recorded for each of the enabled processors.

12. The method of claim 11, and further including:
averaging the utilized performance level over an averaging period which is equal to, or greater than, the recoding period; and
charging the customer based on the amount the averaged utilized performance level exceeds the baseline performance level.

13. The method of claim 12, and further including charging the customer based, in part, on the length of the averaging period.

14. The method of claim 11, wherein a predetermined interval of time is selected as an averaging period, and further including performing the following steps during each of one or more of the averaging periods:
averaging, for each of the recording periods included within the averaging period, the utilized performance levels to obtain an averaged system utilized performance;
calculating an excess utilized performance level as the amount the averaged system utilized performance exceeds the baseline performance level;
calculating an excess consumption for the averaging period as a product of the averaging period and the excess utilized performance level; and
wherein the charging step comprises charging the customer for the excess consumption.

15. The method of claim 16, wherein a predetermined time period is selected as a billing period, and wherein, for each of one or more billing periods, the charging step includes charging the customer for the excess consumption during each of the averaging periods within the billing period.

16. The method of claim 7, wherein the data processing system may be used in any of multiple configurations, and wherein at least one of the multiple configurations includes multiple processing partitions that each includes at least one enabled processor, and further including:
configuring the data processing system in a configuration that includes multiple processing partitions;
determining the maximum performance level of a selected one of the processing partitions;
allocating a portion of the ceiling performance level to the selected processing partition;
deriving a scaling factor=(the allocated portion of the ceiling performance level)/(the maximum performance level); and
scaling the performance of each enable processor in the selected processing partition by the scaling factor.

17. The method of claim 16, and further including repeating the determining, allocating, deriving, and scaling steps for all of the processing partitions.

18. The method of claim 7, wherein the data processing system may be used in any of multiple configurations, and wherein at least one of the multiple configurations includes multiple processing partitions that each includes at least one enabled processor, and further including:
configuring the data processing system in a configuration that includes multiple processing partitions;
selecting a time interval for use as a recording period;
for each of the processors in each of the processing partitions, recording as idle time the time during the recording period wherein work is not being performed by the processor;
for each of the processing partitions, calculating a utilized performance during the recording period based on the maximum performance level of the processing partition and the idle time recorded for each of the enabled processors in the processing partition;
obtaining a system utilized performance during the recording period by adding the utilized performance for each of the processing partitions during the recording period; and
repeating the selecting, recording, calculating and obtaining steps for one or more of the recording periods.

19. The method of claim 18, and further including;
averaging the system utilized performance at predetermined averaging periods that are equal to, or greater than, the recording period; and
charging the customer at predetermined billing periods based on averaged system utilized performance derived for each of the averaging periods within the billing period.

20. The method of claim 18, wherein a predetermined interval of time is selected as an averaging period, and wherein the following step is performed during each of one or more averaging periods:
averaging the system utilized performance obtained for each of the recording periods within the averaging period;
calculating an excess utilized performance level as the amount the averaged system utilized performance exceeds the baseline performance level;
calculating an excess consumption for the averaging time period as the product of the averaging period and the excess utilized performance level; and
wherein the charging step comprises charging the customer for the excess consumption.

21. The method of Clam 20, wherein the charging step includes billing the customer for the excess consumption occurring during each of the averaging periods within a predetermined billing period.

22. A data processing system, comprising:
one or more processors;
a memory coupled to the processors; and
Software Controlled Performance Facility (SCPF) software stored within the memory to monitor performance of at least one of the processors, and to charge a customer based on the performance that is utilized.

23. The system of claim 22, and further including a system console communicatively coupled to the processors to enable one or more of the processors for use within the system; and wherein the processors being monitored are the enabled one or more processors.

24. The system of claim 23, wherein the SCPF software further includes:
means for deriving a system utilized performance for the data processing system based on the amount of time each of the enabled processors is performing work and on a maximum performance level that may be delivered by all of the enabled processors; and
means for charging the customer based on the system utilized performance.

25. The system of claim 24, wherein the system console includes means for configuring the data processing system in any selected one of multiple possible configurations, and wherein the selected configuration determines the maximum performance level.

26. The system of claim 25, wherein the selected configuration includes at least one cache memory coupled to the enabled processors.

27. The system of claim 24, wherein the memory stores data specifying a baseline performance level, and wherein the SCPF software includes means for charging the customer based on the amount the system utilized performance of the enabled processors exceeds the baseline performance level.

28. The system of claim 27, wherein the memory further stores data specifying a ceiling performance level, and wherein the SCPF software includes means for limiting the performance of the data processing system to no more than the ceiling performance level.

29. The system of claim 28, wherein the SCPF software includes means for allowing a user to modify at least one of the baseline performance level and the ceiling performance level.

30. The system of claim 24,
wherein the system console includes means for configuring the data processing system into multiple processing partitions, each including at least one of the enabled processors; and
further including means for monitoring utilized performance of each of the processing partitions based on the amount of time each enabled processor within the processing partition is performing work and on a maximum performance level that may be delivered by the processing partition.

31. The system of claim 30, and further including deriving the system utilized performance as the sum of the utilized performance of each of the processing partitions.

32. The system of claim 30, and further including:
means for averaging the utilized performance of each of the processing partitions over a predetermined averaging time period; and
means for deriving averaged system utilized performance as the sum of the averaged utilized performance of each of the processing partitions over the averaging time period.

33. The system of claim 32, wherein the memory stores data specifying a baseline performance level, and wherein the SCPF includes means for charging the customer based on the amount the averaged system utilized performance exceeds the baseline performance level.

34. The system of claim 33, and wherein the SCPF further includes means for charging the customer based, in part, on the averaging time period.

35. The system of claim 32, and further including billing software for billing the customer at each of predetermined billing time periods base on the averaged system utilized performance for each of the averaging time periods included in the billing time period.

36. The system of claim 33, wherein the billing software includes means for billing the customer at each of predetermined billing time periods based on an amount the averaged system utilized performance exceeds the baseline performance level for each of the averaging time periods included in the billing time period.

37. The system of claim 22, wherein the SCPF includes means for storing performance data describing the monitored performance, and means for allowing the customer to access the performance data.

38. A system for charging for performance of a data processing system having one or more processors, comprising:
means for recording performance of the one or more processors;
means for determining system utilized performance of the data processing system from the recorded performance of the one or more processors; and
means for charging a customer based on the system utilized performance of the data processing system.

39. The system of claim 38, wherein the means for determining utilized performance includes means for determining a maximum performance of the data processing system.

40. The system of claim 39, and further including:
means for obtaining a baseline performance level;
means for determining whether the system utilized performance exceeds the baseline performance level; and
means for charging the customer based upon the amount the system utilized performance exceeds the baseline performance level.

41. The system of claim 40, and further including:
system console means for creating multiple processing partitions that each includes at least one processor;
means for determining a maximum performance level for each of the processing partitions;
means for determining utilized performance of each of the processing partitions from the respective maximum performance level of the processing partition and work performed by the processors included within the processing partition; and
means for determining the system utilized performance as the sum of the utilized performance of all processing partitions.

42. The system of claim 41, and further including:
means for averaging the system utilized performance over an averaging period; and
means for charging the customer based on the system utilized performance over the averaging period and further on the length of the averaging period.
